(19) United States
(12) Patent Application Publication
(10) Pub. No.: US 2011/0120848 A1
(43) Pub. Date: May 26, 2011

(54) LUMINOUS KEYBOARD

(75) Inventors: Chien-Ming Su, Taipei (TW); Chun-Che Wu, Taipei (TW); Chun-Nan Su, Taipei (TW)

(73) Assignee: Primax Electronics Ltd., Taipei (TW)

(21) Appl. No.: 12/634,881

(22) Filed: Dec. 10, 2009

(30) Foreign Application Priority Data
Nov. 20, 2009 (TW) 098139438

(51) Int. Cl. H01H 13/76; H01H 1/10

(52) U.S. Cl. 200/5 A; 200/512

(57) ABSTRACT

A luminous keyboard includes plural keycaps, a membrane circuit board, at least one light-emitting element, and a lower cover. The plural keycaps, the membrane circuit board and the light-emitting element are supported on the lower cover. In addition, the lower cover of the luminous keyboard has a light-guiding function. Since an additional light guide plate is required, the luminous keyboard has simplified configuration and the overall thickness thereof is reduced.

### FIELD OF THE INVENTION

The present invention relates to a keyboard, and more particularly to a luminous keyboard.

### BACKGROUND OF THE INVENTION

A keyboard is a widely-used input device of a computer, a personal digital assistant (PDA), a mobile phone or any other electronic device requiring keys for inputting instructions. The keyboard has a basic function of using an input interface. Generally, a dim environment becomes hindrance from operating the keyboard. Recently, a luminous keyboard has been developed. By using the luminous keyboard, the user may accurately depress desired keys while minimizing the possibility of erroneously depressing keys in the dim environment.

FIG. 1 is a schematic cross-sectional view illustrating a luminous keyboard according to a prior art. As shown in FIG. 1, the luminous keyboard comprises a casing 10, a reflector 11, a light guide plate 12, a membrane circuit board 13, plural elastic members 14, plural keycaps 15 and plural light-emitting elements 16. The light-emitting elements 16, the light guide plate 12, the reflector 11, the membrane circuit board 13, the elastic members 14 and the keycaps 15 are accommodated within the casing 10. When a keycap 15 is depressed by a user, a corresponding elastic member 14 is pushed by the keycap 15 to press down the membrane circuit board 13, so that the membrane circuit board 13 is electrically conducted. The light-emitting elements 16 are arranged at bilateral sides of the light guide plate 12 for emitting light beams. The light beams are incident to the light guide plate 12, and reflected by the reflector 11. The reflected light beams are transmitted through the membrane circuit board 13, the elastic members 14 and the keycaps 15. As a consequence, the keycaps 15 has luminous efficacy.

The luminous keyboard, however, still has some drawbacks. For example, since the components of the conventional luminous keyboard are arranged is a multi-layer stack, the process of assembling the conventional luminous keyboard is very complicated. Moreover, since the casing is required to enclose the components, the casing increases the cost of the conventional luminous keyboard and the process of assembling the casing is time-consuming. Since the conventional luminous keyboard has too many components, it is difficult to reduce overall thickness of the conventional luminous keyboard. In other words, the conventional luminous keyboard fails to meet the requirement of slimness.

### SUMMARY OF THE INVENTION

An object of the present invention provides a luminous keyboard having simplified configurations.

Another object of the present invention provides a luminous keyboard having slim thickness.

In accordance with an aspect of the present invention, there is provided a luminous keyboard. The luminous keyboard includes plural keycaps, a membrane circuit board, at least one light-emitting element, and a lower cover. The membrane circuit board is disposed under the plural keycaps for detecting depressing signals of the plural keycaps. The lower cover has a first surface and a second surface, which are opposed to each other. The plural keycaps, the membrane circuit board and the light-emitting element are supported on the first surface of the lower cover. The second surface of the lower cover is coated with a reflective material. A light beam emitted by the light-emitting element is incident to the first surface of the lower cover, reflected by the second surface of the lower cover, and directed to the plural keycaps.

In an embodiment, plural light guide bumps are formed on the first surface of the lower cover.

In an embodiment, the luminous keyboard further includes plural elastic members, which are arranged between respective keycaps and the membrane circuit board.

In an embodiment, the second surface of the lower cover is a concave surface.

In an embodiment, the lower cover is made of a transparent plastic material.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating a luminous keyboard according to the prior art;

FIG. 2 is a schematic cross-sectional view illustrating a luminous keyboard according to an embodiment of the present invention; and

FIG. 3 is an enlarged fragmentary view of the luminous keyboard of FIG. 2.

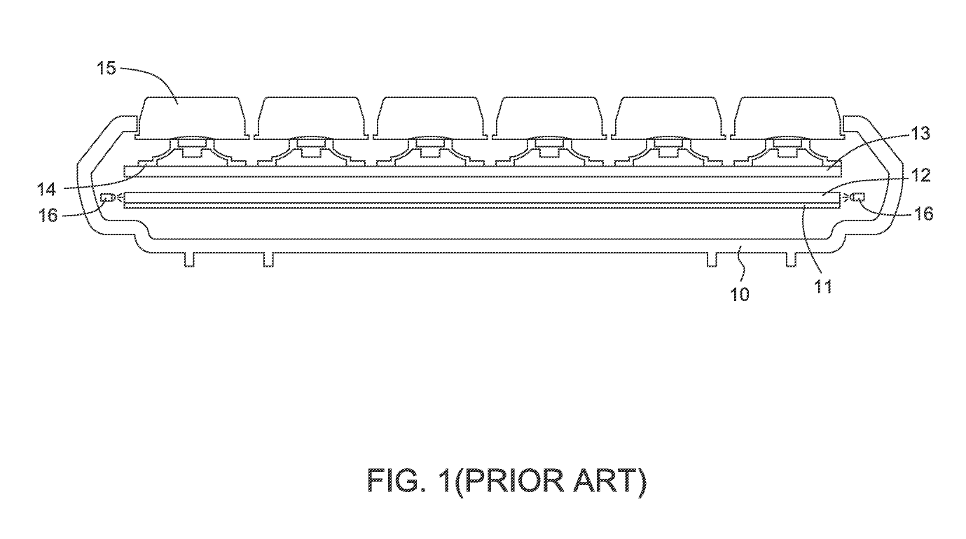

### DETAILED DESCRIPTION OF THE PREFERRED EMBODIMENT

The present invention provides a luminous keyboard. The luminous keyboard has a lower cover with a light-guiding function. By using the luminous keyboard, the configurations are simplified and the overall thickness is reduced, so that the drawbacks encountered from the prior art are overcome.

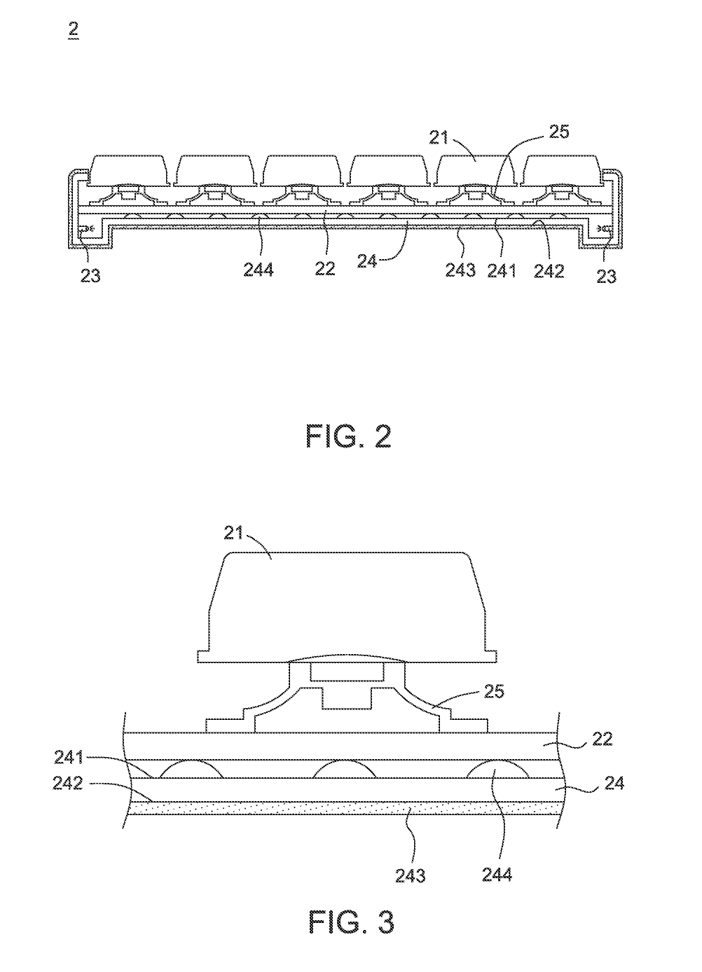

FIG. 2 is a schematic cross-sectional view illustrating a luminous keyboard according to an embodiment of the present invention. FIG. 3 is an enlarged fragmentary view of the luminous keyboard of FIG. 2.

As shown in FIG. 2, the luminous keyboard 2 comprises plural keycaps 21, plural elastic members 25, a membrane circuit board 22, plural light-emitting elements 23 and a lower cover 24.

The lower cover 24 is made of a transparent plastic material. The lower cover 24 comprises a first surface 241 and a second surface 242. The light-emitting elements 23 are arranged at bilateral sides of the lower cover 24. The lower cover 24 is disposed at the lowermost position of the luminous keyboard 2. The keycaps 21, the elastic members 25, the membrane circuit board 22 and the light-emitting elements 23 are supported on the first surface 241 of the lower cover 24. Optionally, plural light guide bumps 244 are formed on the first surface 241 of the lower cover 24 for facilitating uniformly scattering light beams. Moreover, the second surface 242 of the lower cover 24 is a concave surface and a reflective material 243 is coated on the second surface 242 of the lower cover 24.

Please refer to FIG. 3. When a keycap 21 is depressed by a user, a corresponding elastic member 25 is pushed by the keycap 21 to press down the membrane circuit board 25, so that the membrane circuit board 22 is electrically conducted. The light beams emitted by the light-emitting elements 23 are incident to the first surface 241 of the lower cover 24. Since the lower cover 24 is made of a transparent plastic material and the reflective material 243 is coated on the second surface 242 of the lower cover 24, the light beams incident to the first surface 241 of the lower cover 24 are transmitted through the lower cover 24 to the second surface 242, and reflected by the reflective material 243. The light beams reflected by the reflective material 243 are directed to the light guide bumps 244 in the upward direction, so that the light beams are uniformly scattered by the light guide bumps 244. The uniformly-scattered light beams are transmitted through the membrane circuit board 22, the elastic members 25 and the keycaps 21. As a consequence, the keycaps 21 has luminous efficacy. By using the luminous keyboard, the user may accurately depress desired keys in order to prevent from erroneously depressing keys in the dim environment.

From the above description, the lower cover 24 of the luminous keyboard 2 of the present invention may support the keycaps 21, the membrane circuit board 22 and the light-emitting elements 23. In addition, the lower cover 24 of the luminous keyboard 2 has a light-guiding function. Since the light guide plate used in the conventional luminous keyboard is omitted, the luminous keyboard of the present invention has simplified configuration and the overall thickness thereof is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A luminous keyboard comprising:
plural keycaps;
a membrane circuit board disposed under said plural keycaps for detecting depressing signals of said plural keycaps;
at least one light-emitting element; and
a lower cover having a first surface and a second surface, which are opposed to each other, wherein said plural keycaps, said membrane circuit board and said light-emitting element are supported on said first surface of said lower cover, and said second surface of said lower cover is coated with a reflective material,
wherein a light beam emitted by said light-emitting element is incident to said first surface of said lower cover, reflected by said second surface of said lower cover, and directed to said plural keycaps.

2. The luminous keyboard according to claim 1 wherein plural light guide bumps are formed on said first surface of said lower cover.

3. The luminous keyboard according to claim 1 further comprising plural elastic members, which are arranged between respective keycaps and said membrane circuit board.

4. The luminous keyboard according to claim 1 wherein said second surface of said lower cover is a concave surface.

5. The luminous keyboard according to claim 1 wherein said lower cover is made of a transparent plastic material.
